(19) United States
(12) Patent Application Publication
(10) Pub. No.: US 2024/0395166 A1
(43) Pub. Date: Nov. 28, 2024

(54) SECURE MINOR TRANSACTION PLATFORM

(71) Applicant: Bank of America Corporation, Charlotte, NC (US)

(72) Inventors: Sasikumar Purushothaman, Frisco, TX (US); Manu Kurian, Dallas, TX (US)

(21) Appl. No.: 18/201,002

(22) Filed: May 23, 2023

(51) Int. Cl. G09B 19/18

(52) U.S. Cl. CPC G09B 19/18

(57) ABSTRACT

A financial institution may provide a client with a computer program product that may be used to train minor children on investing in financial instruments. An electronic interface may enable the client to delegate control over a portion of the client's investment portfolio to minor children. The delegated control may allow a minor child, using a second electronic interface, to make investment decisions for the assets delegated to the minor child under the supervision of the client. The investments by the minor child may be simulated or may be actual investments. A rules engine may specify client, financial institution, or AI/ML generated rules that govern use of the product. ESG criteria may be used to aid in investment decisions. Statistical graphics, like a pie chart, may be used to display to the client and to the minor children a breakdown of assets held, such as by category.

### FIELD OF THE DISCLOSURE

Aspects of the disclosure relate to computer program products and methods for an adult to educate minor children how to make financial investments using an electronic investment platform used by the adult.

### BACKGROUND OF THE DISCLOSURE

Many young people often do not receive much formal education in how to invest in financial assets, such as stocks, bonds, mutual funds, ETFs, cryptocurrencies, or other assets. As a result, adults, especially young adults, may rely on advisors or may self-educate themselves. However, they may still not fully understand the advice of their investment advisors or how to make good financially-sound decisions in the markets. It may be useful to gain a better understanding of how to best invest while the people are still minor children using an electronic investment platform.

### SUMMARY OF THE DISCLOSURE

It is an object of this invention to provide a computer program product and method to educate minor children in investing in financial instruments.

An online investment education computer program product may include executable instructions that, when executed by a processor on a computer system, provide, to a client of a financial institution using an online, client-accessible investment management application, a first electronic interface. The first electronic interface may be configured to delegate to a minor child access to manage a portion of an investment portfolio, including access to request performance of a financial transaction or investment strategy change involving the portion of the investment portfolio using the electronic interface, and enable the client to supervise the financial transaction or investment strategy change requested by the minor child. The executable instructions may also provide to the minor child, using the investment management application, secure access to a second electronic interface that is configured for the minor child to manage, under the supervision of the client, the portion of the investment portfolio that has been delegated by the client to the minor child. The investment management application may receive, via the second electronic interface, a request from the minor child, to perform the financial transaction or investment strategy change using the portion of the investment portfolio, and execute the requested financial transaction or investment strategy change, using the investment management application, subject to client supervision and to one or more rules relating to the delegation of access to the minor child.

The client supervision may be performed using the first electronic interface. The one or more rules may be defined in a rules engine, associated with the investment management application, by one or more of the client, the financial institution, or by artificial intelligence or machine learning. The first electronic interface may be further configured to enable the client to delegate to a second minor child access to manage a second portion of the investment portfolio that is different from the portion of the investment portfolio that the first minor child has been given access to manage.

The investment portfolio may include, for example, one or more asset types including one or more of stocks, bonds, mutual funds, electronically traded funds (ETFs), cryptocurrencies, or cash. The financial institution may be, for example, one of a brokerage, a bank, a mutual fund company, an insurance company, an online investment platform, or an online trading platform.

A first statistical graphic corresponding to the investment portfolio of the client and a second statistical graphic that is child-specific and corresponds to the investments managed by the minor child may be provided to the client, and the second statistical graphic may be provided to the minor child. The second statistical graphic may be updated upon execution of a requested financial transaction. The first statistical graphic or the second statistical graphic may include a pie chart. The first statistical graphic or the second statistical graphic may be enlarged in size as the types of investments to be visualized are increased and may be reduced in size as the types of investments to be visualized are decreased.

The one or more rules defined in the rules engine may control a delegation of a percentage of the investment portfolio to each of the first and second minor children. The percentage of the investment portfolio that may be delegated to the minor child to manage may be increased or decreased by the client. A cumulative percentage of the investment portfolio that may be delegated to the first minor child and any additional children for management using the investment management application may be limited to less than a total of the investment portfolio of the client.

The one or more rules defined by the client may include parental controls. The one or more rules may include age-based rules. The one or more rules may regulate, for the portion of the investment portfolio for which access may be delegated by the client to the minor child, a limit on a maximum value of each transaction, diversification of assets in the portion of the investment portfolio, or a total number of transactions that may be performed per time interval. The one or more rules may regulate, for the portion of the investment portfolio for which access has been delegated by the client to the minor child, a type of trading or a total number of trades that may be performed. The one or more rules may provide that the minor child gain full ownership of, and access to self-manage without parental supervision, the portion of the investment portfolio that has been delegated to the minor child upon the minor child reaching a predefined age.

The client supervision may include client controls over one or more financial transactions or investment strategy changes requested by the minor child. The client controls may include client approval or prevention of one or more of the one or more financial transactions or investment strategy changes requested by the minor child. The client supervision may be passive such that the client may be kept informed of the requested one or more financial transactions or investment strategy changes.

The secure access by the minor child to manage the portion of the investment portfolio that may be delegated to the minor child may be limited to requesting a simulated financial transaction or an investment strategy change that is performed as a simulation to show potential performance without changing the portion of the investment portfolio delegated to the minor child. The secure access to manage the portion of the investment portfolio that is delegated to the minor child may include access to manage transactions that are to be actually performed.

The executable instructions may provide to the minor child, using the second electronic interface, access to investment-related research or educational materials about investing. The executable instructions may enable the minor child to invest in an asset based on environmental, social, and corporate governance (ESG) criteria specified by the minor child. The executable instructions may obtain an ESG rating for the asset from a ratings platform to determine whether the asset meets the specified ESG criteria. The executable instructions may interface with a proxy engine to obtain the ESG rating from the ratings platform as the client and not the minor child, such as by showing the client's name as the requestor.

A method for providing investment education to minor children may include providing, to a client of an financial institution using an online, client-accessible investment management application, a first electronic interface that is configured to delegate to a minor child access to manage a portion of the investment portfolio, including access to request a financial transaction or investment strategy change involving the portion of the investment portfolio using the electronic interface, and enable the client to supervise the financial transaction or investment strategy change requested by the minor child;

The method may include providing to the minor child, using the investment management application, secure access to a second electronic interface for the minor child to manage, under the supervision of the client, the portion of the investment portfolio that has been delegated by the client to the minor child. The method may include receiving, by the investment management application via the second electronic interface, a request, from the minor child, to perform the financial transaction or investment strategy change. The method may include causing execution of the financial transaction or investment strategy change, using the investment management application, subject to client supervision and to one or more rules defined in a rules engine relating to the delegation of access to the minor child. The client supervision may be performed using the first electronic interface.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system architecture in accordance with principles of the disclosure.

FIG. 2 shows an illustrative apparatus of a device in accordance with principles of the disclosure.

FIG. 3 shows an illustrative snapshot of statistical graphics reflecting an investment portfolio of a client and minor children in accordance with principles of the disclosure.

FIG. 4 shows an illustrative system for investment management by a client and minor children in accordance with principles of the disclosure.

FIG. 5 shows an illustrative engine for managing minor child investments in accordance with principles of the disclosure.

FIG. 6 shows an illustrative interface for a client to enter minor child information in accordance with principles of the disclosure.

FIG. 7A shows an illustrative statistical graphic for illustrating to a minor child the child's investments before a change in investments by the child in accordance with principles of the disclosure.

FIG. 7B shows an illustrative statistical graphic for illustrating to a minor child the child's investments after a change in investments by the child in accordance with principles of the disclosure.

FIG. 8 shows an illustrative example of a flow chart for performing a method for investment education for minor children in accordance with principles of the invention.

### DETAILED DESCRIPTION OF THE DISCLOSURE

The present disclosure relates to computer program products, methods, and apparatus for a client (customer) of a financial institution, such as an investment management entity, to train one or more minor children of the client in investing in financial products under the supervision of the client. As part of this education, a client may delegate rights to a minor child to make investment decisions relating to a portion, such as a percentage, of the client's current investment portfolio, under the supervision of the client. The delegation may provide the minor child with access to manage a portion of the client's investment portfolio. The investment decisions of the minor child may allow the child to reallocate investments to different assets and different types of assets. The rights may allow the minor child to engage in financial investing and trades in financial instruments. The client may be, for example, the parent or guardian of the minor child or children. A reference to a parent herein is inclusive of a parent or guardian of the minor child or children.

The training may be performed using an investment management application that may reside on a platform provided by the financial institution that the client may use for financial investing or online trading. The financial institution may be, for example, a brokerage, a bank, a mutual fund company, an insurance company, an online investment platform, or an online trading platform. The application may be resident, for example, on an application server of a financial institution or at a data center, and may be accessed in various ways, such as via a computer or as an app on a mobile device.

The investments may include various types or categories of investments (assets), such as investments in financial instruments like stocks, bonds, mutual funds, electronically traded funds, cryptocurrency, and cash. Investments may be categorized in different ways, such as by the different types or categories. The manner of categorization may be specified by the client.

Some or all of the financial transactions or investment strategy changes by the minor children may be performed as a simulation only so that the children may learn to understand the potential consequences of their investment decisions. When just performed as a simulation, no actual investing takes place.

Some or all the investments by the minor children may involve actual investing. The client may maintain supervision over any investments by the minor children such that the client may be able to see the requested investments and the client may be given control to approve, with or without possible restrictions, any requested trades by the minor children before any trade by the minor children is executed, whether in simulation or actual trades.

A client may have a first login that provides the client with a first electronic interface for the client to perform trades and supervise a child's investments. Each minor child may be given a separate login to access a second electronic interface that may be child-specific and provide the respective minor child with access to only the minor child's allocation of the investment portfolio. The minor child's access may be limited by having the financial institution assign a separate account number or subaccount number. The separate account or subaccount number may be associated with the client's account. The client may have full access to view and perform the client's transactions and to view and approve or block transactions of the minor children. If the minor children have separate account numbers or subaccounts, the client may be given access to those accounts or subaccounts to maintain supervision of the financial transactions or investment strategy changes that may be requested by the minor children. The client may supervise the minor children's accounts by delegating the client's supervisory rights, at least in part, to a third party, such as the client's investment advisor.

A statistical graphic of the investments, by type or category of overall client investments may be presented to the client along with statistical graphics of the investments for one or more of the minor children associated with the client's account. A statistical graphic of a minor child's account may be presented to the minor child when the minor child logs in so that the minor child may understand its investment allocations by type of category. The statistical graphic for the overall client investments may also be displayed to the minor child for the minor child to appreciate a comparison of allocation.

The statistical graphics may be presented in one or more different ways. For e.g., the graphics may be presented in the form of a pie chart or some other graphical aid, such as a picture of a data store with subdivided by category, or a bar chart that may differentiate different types or categories of investments using separate bars having different magnitudes. The statistical graphics may be displayed on an electronic dashboard that is shown to the user (client or minor child) upon login and shows a snapshot of the current status of the investments. The snapshot shown to the client may include a snapshot of total investments, including investments managed by one or more minor children. The snapshot shown to the minor child may include only the investments managed by that minor child.

A statistical graphic for a client or child may be configured to allow for a client or minor child to click on a particular section of the statistical graphic to drill down further to view a list of investments, or top investments (e.g., top 10 investments, held by the individual within that type or category. The size of the statistical graphic that is displayed may get smaller or larger depending on a change in investments. For example, in embodiments, the size of the graphic may grow when the value of assets owned by the client or minor child increases. As another example, the size of the graphic may grow based on an increase in the diversification (e.g., number of types of investments). This may provide visual feedback to the minor child.

The investment process for the minor children may be subject to a set of rules stored in a rules engine. The rules in the rules engine may be defined by the client, by artificial intelligence (AI)/machine learning (ML), by the financial institution, by the government, or by some other entity. The rules may govern the interactions between the client, the minor children, and the financial institution. The rules may include parental controls or other automated rules. The rules may be hard rules, which cannot be changed, and soft rules, which may be changed.

Parental (guardian) controls may include setup of minor child accounts or subaccounts, establishing a percentage of the portfolio to be delegated for management by each minor child, adjusting soft rules in the rules engine, or specifying whether a child has ESG permissions.

The rules may be based on different factors. The rules may be age-based, such that one or more rules may be applied differently based on an age of each minor child. The rules may regulate, for the portion of the investment portfolio for which access has been delegated by the client to the minor child, a limit on a maximum value of each transaction, diversification of assets in the portion of the investment portfolio, or a total number of transactions that may be performed per time interval. The rules may be set to control various aspects of trading such as, for example, an amount of each trade, a total number of trades to be performed per time interval, a total number of trades that may performed, a limit on an amount of an asset type to be traded, diversification of the assets in the investment portfolio, or a type of trading. The rules may regulate a type of trading or a total number of trades that may be performed by the minor child. Certain rules set by the financial institution may apply to all clients of the financial institution.

Each minor child who is given authorization to trade under the client's supervision may receive an equal percentage of the client's investment portfolio (such as 20% to each of three children) to manage or the minor children may be given differing percentages of the investment portion. The client may reduce or eliminate the allocation to a particular minor child or to the minor children.

The amount of the investment portfolio that is delegated to each of the minor children to manage may be subject to the set of controlling rules specified in the rules engine. The rules may relate to various aspects of the investment decisions. The following are some non-limiting examples of rules that may be specified in the rules engine.

The rules may provide for an age-based increase in the percentage that is delegated to a child upon reaching a certain age. For example, a minor child who turns 15 may get an automated increase in the percentage of 1 or 2 percent. A minor child may get another percentage automated increase of 1 or 2 percent.

The rules may provide for an adjustment based on investment performance by the minor child. For example, a decrease in performance may result in an automated decrease in the percentage or value of the investment portfolio delegated for management by that minor child.

The rules may specify that a cumulative percentage of the investment portfolio that may be delegated to the first minor child and to any additional minor children for management is limited to less than a total of the investment portfolio of the client.

The rules may stipulate that only certain types of trading are permitted to be arranged by the minor child. For example, regular trading may be permitted but day trading may not be permitted.

The rules may provide for a portion of the portfolio allocated to a minor child to transfer to a separate account operated by the child, such as when the minor child reaches an age where the child becomes an adult. The separate account may become free of client supervision at that time.

The rules may provide for a percentage of profits made by the minor children (e.g., 5-10%) be returned to the management by the children, rather than by the minor children.

As part of educating the minor child(ren) in investing, the second electronic interface may provide to the minor child or children access to investment-related research or educational materials about investing, including investing in general, or materials about a particular asset of interest. The research or materials may be compiled by an AI/ML engine that is part of, or is coupled to, the investment management application.

One or more minor children associated with the client may be interested in investing based at least in part on environmental, social, and corporate governance (ESG) criteria specified by the minor child. The minor child may be given the ability to specify investments based on the criteria. The client may specify in the parental controls or in the rules engine whether the minor child investment plan may be based on one or more ESG criteria. The ESG criteria may be incorporated into the rules engine. The minor child or the client may obtain an ESG rating from a ratings platform, to determine whether an asset, such as a company's stock, meets specific ESG criteria before trading in that asset. The ESG criteria may be requested by the investment management application on an investment management platform. One or more rules may be set up in the rules engine to specify required ESG criteria for investing in, maintaining, or divesting an investment in the asset. Because a minor child may not be permitted to access an ESG rating platform, the client may utilize an interface to a proxy engine that may be provided by the financial institution to obtain the ESG rating from the rating platform as the client and not the minor child. Thus, the proxy engine may not disclose that the party interested in ESG rating is the minor child.

Illustrative embodiments of methods, systems, and apparatus in accordance with the principles of the invention will now be described with reference to the accompanying drawings, which form a part hereof. It is to be understood that other embodiments may be used, and structural, functional, and procedural modifications may be made without departing from the scope and spirit of the present invention.

The drawings show illustrative features of methods, systems, and apparatus in accordance with the principles of the invention. The features are illustrated in the context of selected embodiments. It will be understood that features shown in connection with one of the embodiments may be practiced in accordance with the principles of the invention along with features shown in connection with another of the embodiments.

The methods, apparatus, computer program products, and systems described herein are illustrative and may involve some or all the steps of the illustrative methods and/or some or all of the features of the illustrative system or apparatus. The steps of the methods may be performed in an order other than the order shown or described herein. Some embodiments may omit steps shown or described in connection with the illustrative methods. Some embodiments may include steps that are not shown or described in connection with the illustrative methods, but rather are shown or described in a different portion of the specification.

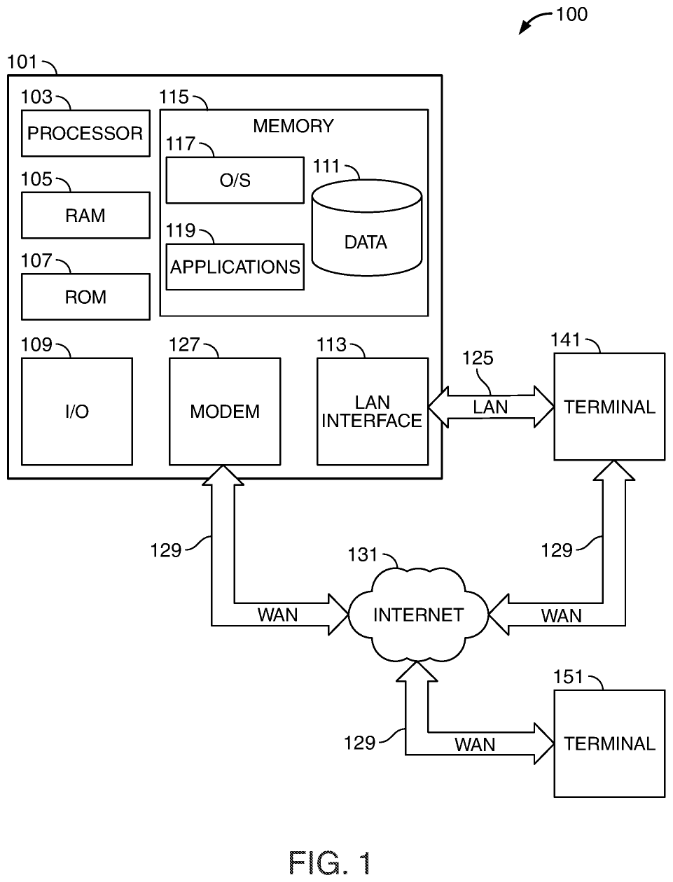

FIG. 1 shows an illustrative block diagram of system 100 that includes computer 101. Computer 101 may alternatively be referred to herein as an “engine,” “server” or a “computing device.” Computer 101 may be any computing device described herein, such as the computing devices running on a computer, smart phones, smart cars, smart cards, and any other mobile device described herein. Elements of system 100, including computer 101, may be used to implement various aspects of the systems and methods disclosed herein.

Computer 101 may have a processor 103 for controlling the operation of the device and its associated components, and may include RAM 105, ROM 107, input/output circuit 109, and a non-transitory or non-volatile memory 115. Machine-readable memory may be configured to store information in machine-readable data structures. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of computer 101. Memory 115 may also store videos, text, and/or audio assistance files. The data stored in Memory 115 may also be stored in cache memory, or any other suitable memory.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all the elements described above relative to computer 101.

In some embodiments, computer 101 and/or Terminals 141 and 151 may be any of mobile devices that may be in electronic communication with consumer device 106 via LAN, WAN, or any other suitable short-range communication when a network connection may not be established.

When used in a LAN networking environment, computer 101 is connected to LAN 125 through a LAN interface 113 or an adapter. When used in a WAN networking environment, computer 101 may include a communications device, such as modem 127 or other means, for establishing communications over WAN 129, such as Internet 131.

In some embodiments, computer 101 may be connected to one or more other systems via a short-range communication network (not shown). In these embodiments, computer 101 may communicate with one or more other terminals 141 and 151, such as the mobile devices described herein etc., using a personal area network (PAN) such as Bluetooth®, NFC (Near Field Communication), ZigBee, or any other suitable personal area network.

It will be appreciated that the network connections shown are illustrative and other means of establishing a communications link between computers may be used. The existence of various well-known protocols such as TCP/IP, Ethernet, NFT, HTTP, and the like is presumed, and the system can be operated in a client-server configuration to permit retrieval of data from a web-based server or API (Application Programming Interface). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may use one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may use the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry™, tablet, smartphone, or any other computing system for receiving, storing, transmitting and/or displaying relevant information. Terminal 151 and/or terminal 141 may be one or more user devices. Terminals 151 and 141 may be identical to computer 101 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smartphones, multiprocessor systems, microprocessor-based systems, cloud-based systems, programmable consumer electronics, network PCs, minicomputers, mainframe computers, distributed computing environments that include any of the above systems or devices, and the like.

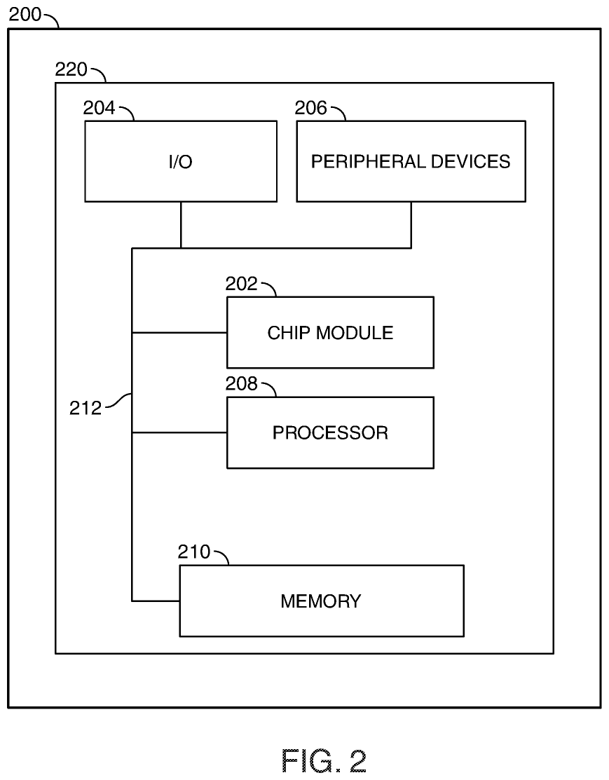

FIG. 2 shows illustrative apparatus 200, which may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

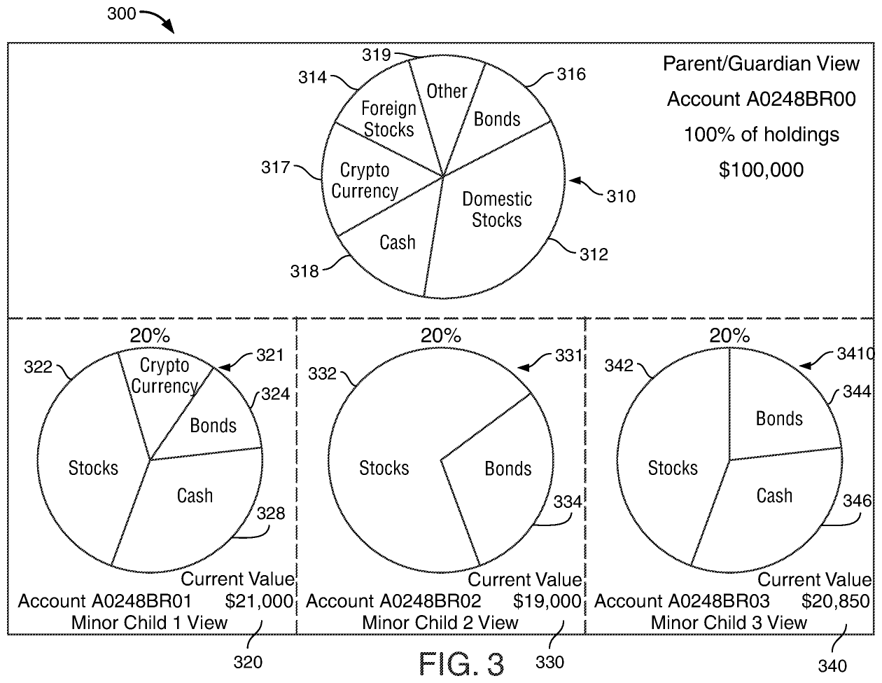

FIG. 3 shows an illustrative snapshot 300 of statistical graphics reflecting an example of an investment portfolio of a client and portions of the portfolio that may be delegated to three minor children of the client in accordance with the disclosure.

The client may be the parent or guardian of the minor children. The client in the illustrated example may have initially delegated 20% of the portfolio 310 to each of the three minor children. The assets delegated by the client may be delegated as specific assets or may be initially delegated in proportion to the asset types, or by some other allocation. The minor children may be inclined to reallocate the holdings that have been delegated to them so that they may hold different asset allocations from the client and different allocations from each other. Hence, the holdings may have a different current value than the initial value as shown in the figure.

A client may be assigned a client account number by the financial institution as shown (e.g., A0248BR00) and the minor children accounts may be assigned account numbers. The children's account number may be based on the client account number. For example, minor child 1 may be assigned account number A0248BR01, minor child 2 may be assigned account number A0248BR02, and minor child 3 may be assigned account number A0248BR03.

The assets within the client investment portfolio and the sub-portfolios of the minor children may be illustrated with statistical graphics, such as a pie chart. A client pie chart 310 may be used to reflect 100% of the investment and pie charts 320, 330, 340 may be used to reflect the investments delegated to the minor children. The categories used to categorize the investments in the pie charts may differ. In embodiments, other categories may be used, such as, for example, stocks, fixed income, or cash. In embodiments, the portfolios may be illustrated with other forms of statistical graphics, such bar graphs or data stores. In this example, the client pie chart may reflect that the client may hold a mix of domestic stocks 312, foreign stocks 314, bonds 316, cryptocurrency 317, cash 318, and “other” investments 319. Investment portfolios for three minor children investment may differ. Minor child 1 may have a mix of stocks, 322, bonds 324, cryptocurrency 326, and cash 328. Minor child 2 may have a mix of stocks 332 and bonds 334. Minor child 3 may have a mix of stocks 342, bonds 344, and cash 346.

The pie charts may all be displayed on a client interface to the investment management application as a parent/guardian view 300 for the client to have a portfolio overview and to assist in supervising the minor children's investments. A minor child may be allowed to only see its own pie chart on the respective minor child's interface to the investment management application. For example, minor child 1 may see pie chart 320, minor child 2 may see pie chart 322, and minor child 3 may see pie chart 324. The parent/guardian view may also display other account information, including an account number and a value of assets in each portfolio. The minor children's accounts may be subaccounts of the client account, as shown.

The pie charts may be interactive such that clicking on a particular category shown in the pie may cause the display of assets within that category. For example, a list of the top ten stocks, or all stocks, may be displayed when clicking on the category “stocks.”

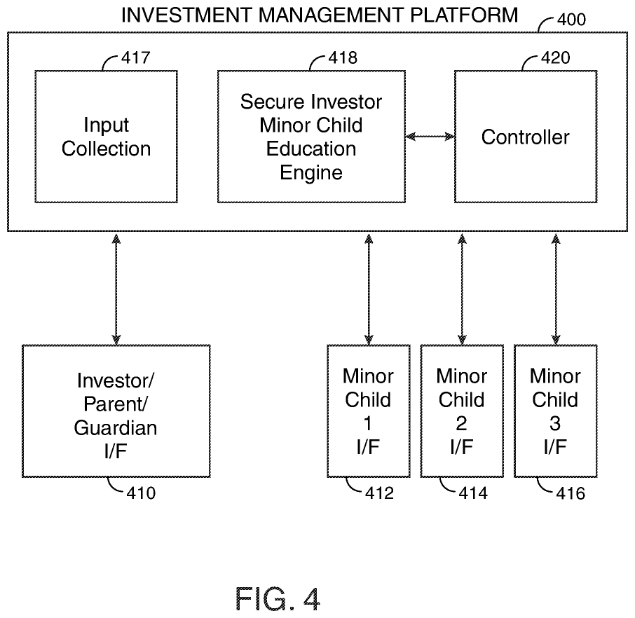

FIG. 4 shows an illustrative system for investment management by a client and the minor children. The investor and minor children 1-3 may each interact with an investor management platform 400 that may include an investor management application to manage investments. Investor and minor children may interact with the investment management application using a device. Each of the investor and minor children may have their own devices, such as devices 410, 412, 414, 416 or one or more of them may share a device. The devices may provide a respective interface on the device for investment management. The device may be, for example, a desktop or laptop computer, a smartphone, or some other device. Investment management application may include an input collector 417 to collect data from the client or minor children, a controller 420, and an engine 418 (module) that may be used to support the minor child investor management. Engine 418 may be considered a secure investor minor child education engine.

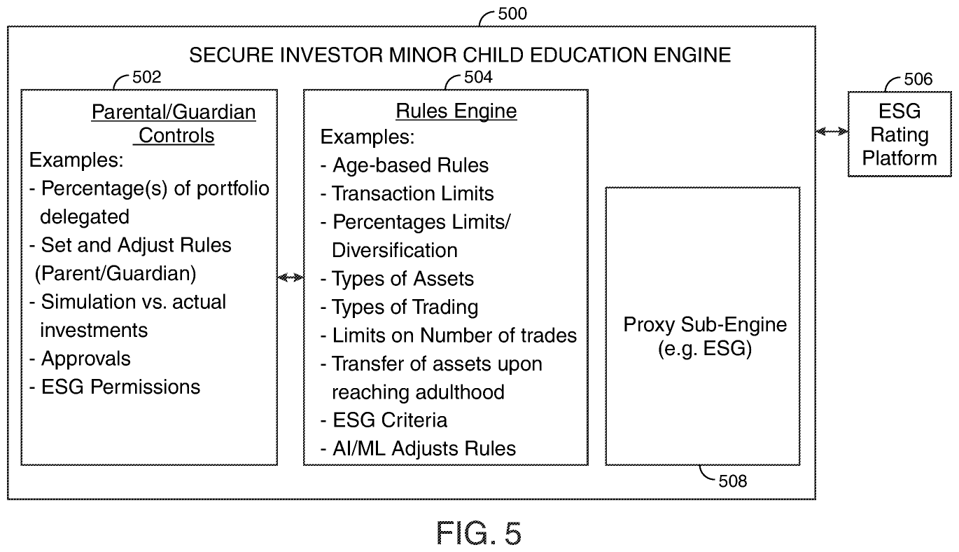

FIG. 5 shows an illustrative minor child education engine 500 that may include parental/guardian controls 502, a rules engine 504, and a possible outside proxy sub-engine 508.

Parental/guardian controls 502 may reflect settings that may be entered by the client to set up the accounts/subaccounts for the minor children. They may include percentage of portfolio or specific assets to be delegated for management by minor children, setting or modifying of rules to govern the delegation of investment authorization, indicating whether the investments by the children may only be simulated or may be actual investments, subject to client supervision, and specifying whether the client gives permissions for one or more of the minor children to invest based on specific criteria, such as, for example, ESG criteria.

Rules engine 504 may include, for example, rules that may be set by the client, by AI/ML, or by the investment management entity that maintains the investment management application. Such rules may include age-based rules that may adjust the rules for each of the minor children based on age. For example, a 15 year old child may receive a smaller delegation of the client's portfolio than a 17 year old child. The rules engine may set percentage limits on the portion of the portfolio that may be allocated to each minor child. The rules engine may control the types of assets that may be allocated for management by the minor child, limit the types of trading that the minor child may perform, limits on the number of trades per time interval, transaction limits, rules for assets to be transferred to a child when the child reaches adulthood, ESG criteria that may be used for investing. The rules engine may include hard and soft rules. The rules engine and parental controls may limit some similar functionality. The rules engine may include the parental controls. Engine 500 may also include an outside proxy (sub)engine 508 that may be used to interact with an ESG ratings platform 506 that may indicate the ESG ratings for particular assets. These ESG ratings may be compared to specified ESG criteria for investment determinations. The proxy engine may reflect the client's identity to maintain the privacy of the minor children.

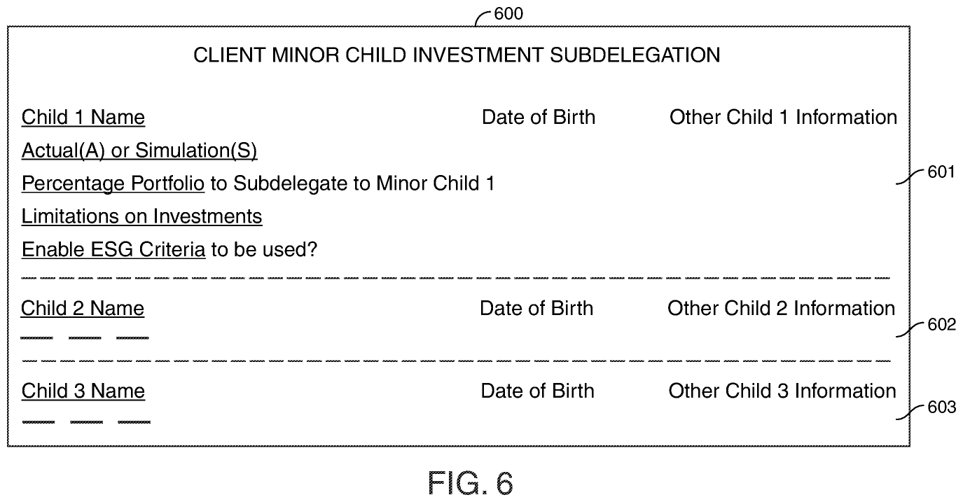

FIG. 6 shows an illustrative electronic screen 600 on an electronic interface on which a client may enter minor child information in accordance with principles of the disclosure. The client may enter various child-related information on the interface. The client may have an option of entering parental control-related information for each child on the same screen or may enter the parental control information on a different screen. Examples of fields to be completed are shown for child 1 are shown as 601 and similar fields may be provided to the client on screen 600 at 602 and 603 to enter information about its other minor children minor child 2 and minor child 3. The client may also specify on this screen or on one or more other screens its rules for delegating rights to a minor child or minor children.

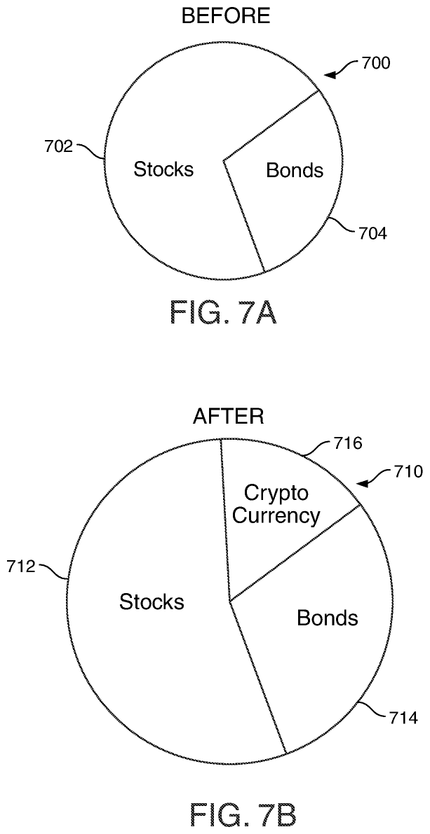

FIGS. 7A and 7B, in combination, show that the statistical graphics that may be displayed for a client or minor child investments may change in size. The increase or decrease of the pie chart may reflect, for example, more or fewer diversification of assets. FIG. 7A illustrates an illustrative smaller pie chart 700 that includes assets of stocks 702 and bonds 704. FIG. 7B illustrates a larger pie chart 710 that reflects assets of stocks 712, bonds 714, and the addition of cryptocurrency 716.

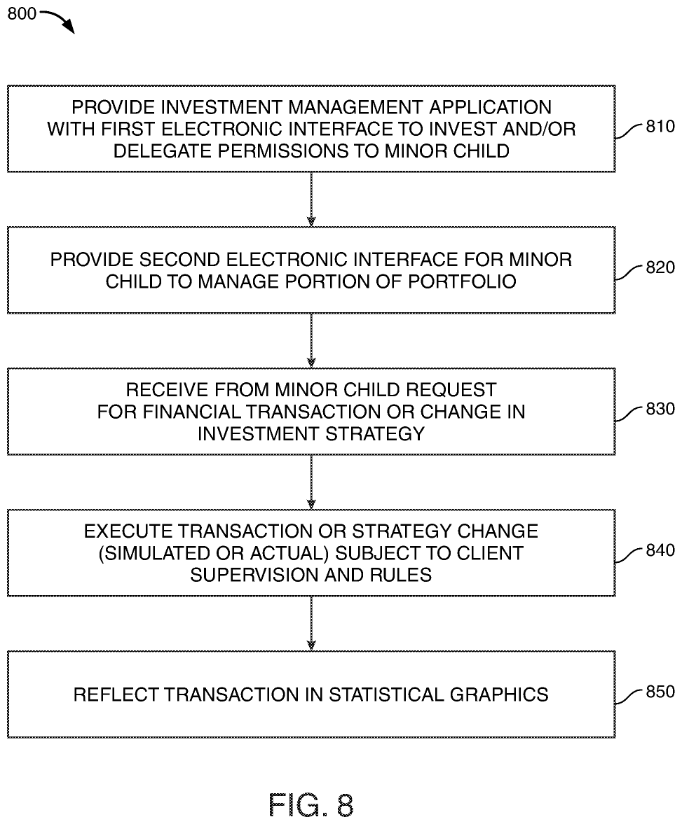

FIG. 8 shows an illustrative example of a flow chart 800 for performing a method for investment education for minor children.

At step 810, a financial institution may provide an investment management application with a first electronic interface on which a client investor may use for delegating permissions to the client's minor child or children to invest or propose an investment reallocation of a portion of the client's portfolio. The client may also use the interface to provide to the financial institution information about the minors, if the financial institution does not already have this information, and specify rules for allowing the minors to invest. Examples of possible rules are described above. The rules may be child specific or may apply to all of the children. The interface may display statistical graphics, like a pie chart, for each of the investor and the minor children so the investor may visualize the categorizations of its investments and proposed or actual investments by the minor children. The same interface may also be configured for the client to manage its investments, or the client may use a separate interface to manage its investments.

At step 820, a second electronic interface may be provided to each minor child to manage a portion of the portfolio. The interface may be customized to the minor child's account/subaccount associated with the client. This interface may display options for the minor child to select investments or types of investments for its portfolio. A statistical graphic, like a pie chart, may be used to visualize the categorization of the proposed or actual investments of the minor child. Each minor child may have its own electronic interface.

At step 830, the minor child may enter a request for a financial transaction or change in investment strategy at the electronic interface. The activity of the minor child on the interface may be supervised by the client. The client may have approval or disapproval rights over the requested transaction or may be able to apply restrictions on the transaction. The client may also just monitor the transaction passively. The child may request financial transactions or changes in investment strategies.

At step 840, the financial transaction or change in investment strategy may be executed in a simulated manner or may be performed as actual transactions or changes. The choice between simulated or actual transactions or changes may depend on permissions of the client (parent/guardian), the financial institution, or the minor child's request for either a simulation, or an actual performance of a transaction or change.

At step 850, the transaction may be reflected in the child-specific statistical graphics. The transaction may also be reflected in the statistical graphic of the client that may be displayed.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods, systems, apparatuses, and computer program products may implement online investment education that may teach the minor children financial literacy and how to invest. Persons skilled in the art will appreciate that the present invention can be practiced by other than the described embodiments, which are presented for purposes of illustration rather than of limitation.

What is claimed is:

1. An online investment education computer program product comprising executable instructions that, when executed by a processor on a computer system:
provide, to a client of a financial institution using an online, client-accessible investment management application, a first electronic interface that is configured to:
delegate to a minor child access to manage a portion of an investment portfolio, including access to request performance of a financial transaction or investment strategy change involving the portion of the investment portfolio using the electronic interface; and
enable the client to supervise the financial transaction requested by the minor child;
provide to the minor child, using the investment management application, secure access to a second electronic interface that is configured for the minor child to manage, under the supervision of the client, the portion of the investment portfolio that has been delegated by the client to the minor child;
receive, by the investment management application via the second electronic interface, a request from the minor child to perform the financial transaction or investment strategy change using the portion of the investment portfolio; and
execute the financial transaction or investment strategy change, using the investment management application, subject to client supervision and to one or more rules relating to the delegation of access to the minor child.

2. The computer program product of claim 1, wherein the one or more rules are defined in a rules engine, associated with the investment management application, by one or more of the client, the financial institution, or by artificial intelligence or machine learning.

3. The computer program product of claim 1, wherein the executable instructions, further:
provides to the client a first statistical graphic corresponding to the investment portfolio of the client and a second statistical graphic that is child-specific and corresponds to the investments managed by the minor child; and
provides to the minor child the second statistical graphic;
wherein the second statistical graphic is updated upon execution of the financial transaction or investment strategy change.

4. The computer program product of claim 1, wherein a cumulative percentage of the investment portfolio that may be delegated to the minor child and any additional children for management using the investment management application is limited to less than a total of the investment portfolio of the client.

5. The computer program product of claim 1, wherein the client supervision comprises client controls over the financial transaction or investment strategy change requested by the minor child.

6. The computer program product of claim 5, wherein the client controls comprise client approval or prevention of one or more of the financial transaction or investment strategy change requested by the minor child.

7. The computer program product of claim 1, wherein the client supervision is passive such that the client is kept informed of the requested financial transaction or investment strategy change.

8. The computer program product of claim 1, wherein the secure access by the minor child to manage the portion of the investment portfolio that is delegated to the minor child is limited to requesting simulated financial transactions or investment strategy changes that are performed as simulations to show potential performance without changing the portion of the investment portfolio delegated to the minor child.

9. The computer program product of claim 1, wherein the secure access to manage the portion of the investment portfolio that is delegated to the minor child includes access to manage financial transactions or investment changes that are to be actually performed.

10. The computer program product of claim 1, wherein the one or more rules defined by the client include parental controls.

11. The computer program product of claim 1, wherein the one or more rules include age-based rules.

12. The computer program product of claim 1, wherein the one or more rules regulate, for the portion of the investment portfolio for which access may be delegated by the client to the minor child, a limit on a maximum value of each transaction, diversification of assets in the portion of the investment portfolio, or a total number of transactions that may be performed per time interval.

13. The computer program product of claim 1, wherein the one or more rules regulate, for the portion of the investment portfolio for which access has been delegated by the client to the minor child, a type of trading or a total number of trades that may be performed.

14. The computer program product of claim 1, wherein the one or more rules provide that the minor child gain full ownership of, and access to self-manage without parental supervision, the portion of the investment portfolio that has been delegated to the minor child upon the minor child reaching a predefined age.

15. The computer program product of claim 1, wherein the executable instructions further enable the minor child to invest in an asset based on environmental, social, and corporate governance (ESG) criteria specified by the minor child.

16. The computer program product of claim 15, wherein the executable instructions further obtain an ESG rating for the asset from a ratings platform to determine whether the asset meets the specified ESG criteria.

17. The computer program product of claim 16, wherein the executable instructions further interface with a proxy engine to obtain the ESG rating from the ratings platform as the client and not the minor child.

18. The computer program product of claim 1, wherein the investment portfolio comprises one or more asset types including one or more of stocks, bonds, mutual funds, electronically traded funds (ETFs), cryptocurrencies, or cash.

19. The computer program product of claim 1, wherein the financial institution is one of a brokerage, a bank, a mutual fund company, an insurance company, an online investment platform, or an online trading platform.

20. A method for providing investment education to minor children, comprising:
providing, to a client of a financial institution using an online, client-accessible investment management application, a first electronic interface that is configured to:
delegate to a minor child access to manage a portion of the investment portfolio, including access to request a financial transaction or investment strategy change involving the portion of the investment portfolio using the electronic interface; and
enable the client to supervise the financial transaction requested by the minor child;
providing to the minor child, using the investment management application, secure access to a second electronic interface for the minor child to manage, under the supervision of the client, the portion of the investment portfolio that has been delegated by the client to the minor child;
receiving, by the investment management application via the second electronic interface, a request from the minor child to perform the financial transaction or investment strategy change; and
causing execution of the requested financial transaction or investment strategy change, using the investment management application, subject to client supervision and to one or more rules defined in a rules engine relating to the delegation of access to the minor child.
